(19) United States
(12) Patent Application Publication
(10) Pub. No.: US 2005/0279611 A1
(43) Pub. Date: Dec. 22, 2005

(54) Actuating device for a moving sidewalk

(75) Inventors: Marc Ossendorf, Bochum (DE); Alexander Pietz, Berlin-Grunewald (DE)

Correspondence Address: VENABLE LLP, P.O. BOX 34385, WASHINGTON, DC, 20045-9998, US

(73) Assignee: KONE CORPORATION, Helsinki (FI)

(21) Appl. No.: 11/212,882

(22) Filed: Aug. 29, 2005

Related U.S. Application Data
(63) Continuation of application No. PCT/DE04/00359, filed on Feb. 25, 2004.

(30) Foreign Application Priority Data
Feb. 27, 2003 (DE) 103 08 418.5

(51) Int. Cl. B66B 21/10

(52) U.S. Cl. 198/321

(57) ABSTRACT

Each pallet of a moving walkway has a surface which faces a drive belt and which includes a receiving area. A drive belt includes projections spaced at predetermined intervals and directed toward the respective pallets and adapted to obtain a form-fit connection between each projection and a respective one of the receiving areas.

### CROSS-REFERENCE TO RELATED APPLICATION

This is a continuation of International Patent Application No. PCT/DE2004/000359 filed Feb. 25, 2004, designating the United States and claiming priority of German Patent Application No. 103 08 418.5 filed Feb. 27, 2003, the disclosures of both foregoing applications being incorporated herein by reference.

### BACKGROUND OF THE INVENTION

The invention relates to a device for connecting at least one drive belt or parts of drive belts to a pallet of a moving walkway.

German patent document DE-U 201 00 833 discloses an escalator or a moving walkway having a step or pallet band, which is driven by drive elements, which extend on both sides of the band or centrally beneath the band, and which rotate between respectively one reversing wheel and one drive wheel, wherein the steps or pallets are respectively driven at drive points of each drive element. The drive element is a toothed belt, which comprises blocks, wherein one block is respectively connected to one step or pallet at the drive point. The blocks comprise vulcanized rings, collets or brackets, in which axes of the steps or pallets engage.

The manufacture of this drive belt requires a high effort and it is in particular difficult to handle with repair works at site, since for exchanging parts of the belt(s), usually a welding of the belt ends is the only suitable measure.

German patent document DE-A 1816611 describes a drive for the step band of a moving walkway, containing at least one drive wheel for a tension member, connected with the steps, whereby the tension member is in engagement with the drive wheel. The tension member can be a toothed belt made of rubber or synthetic material containing steel cords directed in a longitudinal direction of the toothed belt.

French patent document FR-A 2,224,375 describes a moving walkway with a revolving metallic band, the band containing bearing elements made of caoutchouc on which the pallets of the moving walkway are supported. The connection between the band, the pallets and the bearing elements is realised, respectively, by screws, rivets, vulcanization or the like.

British patent document GB-A 2,290,515 discloses a potato sorting drum, containing two spaced conveying bands, consisting of a plurality of transporting rods. The end parts of the bands have profiled areas formed in an opposite direction, to be fit into each other, the profiled areas are positioned to each other by the end of a rod.

### SUMMARY OF THE INVENTION

It is an object of the invention to provide a system for the simple connection of belts and pallets, which can work without welding the belt ends and thus permits a simple installation, even if damaged pieces of the drive belt have to be replaced.

The above and other objects are accomplished according to one embodiment of the invention by the provision an arrangement, comprising: a moving walkway comprised of pallets, each pallet having a surface for facing a drive belt, the surface of each pallet including a receiving area; and a drive belt including projections spaced at predetermined intervals and directed toward the respective pallets and adapted to obtain a form-fit connection between each projection and a respective one of the receiving areas.

According to another embodiment, the belt is a segmented drive belt comprised of drive belt parts, each drive belt part having opposite end areas each having a guiding area that obtains a form-fit connection with the guide area of an adjacent drive belt part.

On their back side, i.e., the side facing the pallet, the drive belts may possess projections in the form of an eye, which can be connected in a form-fit way to the respective receiving area of the pallet by a through connection.

The connecting system according to the invention allows a simple plug-in type or screw connection, which works without welding the belt ends and thus allows a simple mounting also at an installation site, if damaged pieces have to be replaced.

According to another aspect of the invention, the projections are alternately positioned in the center and on the inner and outer (lateral) sides corresponding to the pallet pitch. This measure permits assurance that by forming guiding areas at the ends of the drive belts or the parts of drive belts, a form-fit connection for closing the belt ends, in particular in the region of the projections/receiving areas, can be achieved.

For improving the power flux, several drive belts may be guided in parallel, wherein care must be taken that several drive belts are juxtaposed.

### BRIEF DESCRIPTION OF THE DRAWINGS

The subject of invention is represented by means of an exemplary embodiment in the drawing and described as follows.

FIGS. 1a and 1b are schematics showing different views of a drive belt.

FIGS. 2a and 2b show schematic representations of a connection area of a segmented drive belt according to FIG. 1.

FIG. 3 is a schematic which shows the connection of the drive belt to pallets of a partially represented moving walkway.

### DETAILED DESCRIPTION OF THE INVENTION

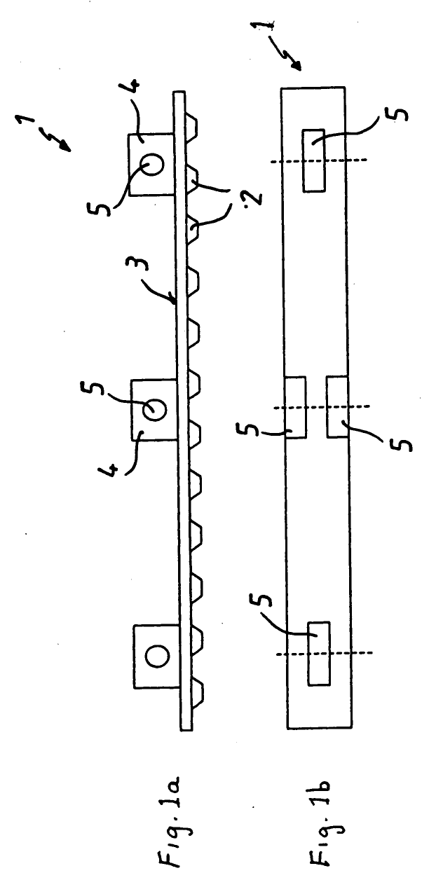

FIG. 1a shows a drive belt 1 in the form of a toothed belt made, for example, of polyurethane, which is provided on one side with a corresponding tooth profile 2. On the side opposing the tooth profile 2, the drive belt 1 is provided with projections 4 having an eye form, which are each provided with a through hole 5. As shown in FIG. 1b, the projections 4 are alternating, i.e. they are placed in the centre on the one hand and on the outer (lateral) sides on the other hand.

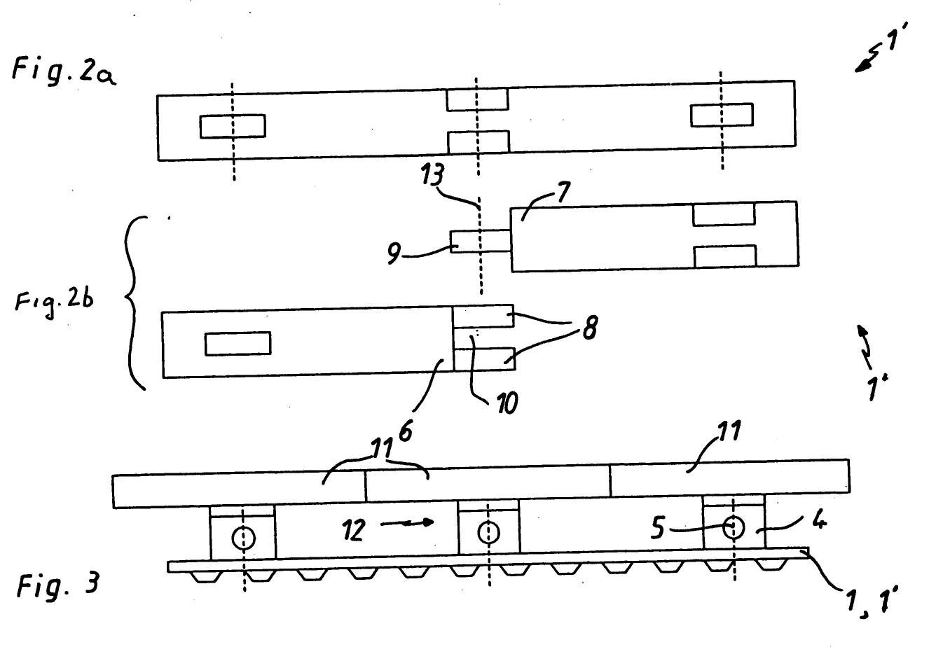

FIGS. 2a and 2b show two juxtaposed segmented drive belts 1′. The drive belt 1′ in FIG. 2a is not divided. The drive belt 1′ in FIG. 2b is cut and shows guiding areas 8, 9 at the ends 6, 7 thereof. Herein, guiding area 9 has the form of a bracket, whereas guiding area 8 comprises a receiving area 10 for the bracket.

FIG. 3 shows a connection of drive belt 1 or 1′ comprising the projections 4 and the through holes 5 to pallets 11 of a partially represented moving walkway. The pallets 11 have receiving areas 12, which can be connected to the projections 4 of drive belt 1 in a form-fit way, wherein a plane of division 13 is advantageously provided in the region of the projections 4 and the receiving areas 12. The projections 4 have a mutual distance from each other, such that they can be respectively brought into active relation with an associated receiving area 12 of the pallet 11. Herein, the pallets 11 are very small, so that a small rotation radii of the pallets 11 can be realized during reversing.

The invention has been described in detail with respect to referred embodiments, and it will now be apparent from the foregoing to those skilled in the art, that changes and modifications may be made without departing from the invention in its broader aspects, and the invention, therefore, as defined in the appended claims, is intended to cover all such changes and modifications that fall within the true spirit of the invention.

1. An arrangement, comprising:
a moving walkway comprised of pallets, each pallet having a surface for facing a drive belt, the surface of each pallet including a receiving area; and
a drive belt including projections spaced at predetermined intervals and directed toward the respective pallets and adapted to obtain a form-fit connection between each projection and a respective one of the receiving areas.

2. The arrangement according to claim 1, wherein the drive belt is a segmented drive belt comprised of drive belt parts, each drive belt part having opposite end areas each having a guiding area that obtains a form-fit connection with the guide area of an adjacent drive belt part.

3. The arrangement according to claim 2, wherein the guiding area at one end area of each drive belt part comprises a web and the guiding area at the opposite end area comprises a support that encompasses the web at the end area of the adjacent drive belt part.

4. The arrangement according to claim 2, wherein the form-fit connection of guiding areas is located in a region of the projections of the drive belt.

5. The arrangement according to claim 1, wherein the drive belt comprises a toothed belt made of polyurethane.

6. The arrangement according to claim 1, wherein the projections, as seen in a longitudinal direction of the drive belt, are alternately located in the center of the drive belt and on the outer sides of the drive belt.
